(19) United States
(12) Patent Application Publication
(10) Pub. No.: US 2013/0063053 A1
(43) Pub. Date: Mar. 14, 2013

(54) SECURING APPARATUS FOR FURNITURE DRIVE

(71) Applicant: Julius Blum GmbH, Hochst (AT)

(72) Inventor: Uwe SCHEFFKNECHT, Hochst (AT)

(73) Assignee: JULIUS BLUM GMBH, Hochst (AT)

(21) Appl. No.: 13/672,982

(22) Filed: Nov. 9, 2012

Related U.S. Application Data
(63) Continuation of application No. PCT/AT2011/000190, filed on Apr. 19, 2011.

(30) Foreign Application Priority Data
May 10, 2010 (AT) A 782/2010

(51) Int. Cl. H02P 5/00

(52) U.S. Cl. CPC H02P 5/00
USPC 318/103

(57) ABSTRACT

Securing apparatus for at least one electrical furniture drive of a movable furniture part, wherein the securing apparatus prevents the simultaneous opening of moveable furniture parts which are at risk of colliding, wherein the securing apparatus has at least two—preferably three—control connections to which signal lines of sensors of movable furniture parts and/or signal lines of the at least one electrical furniture drive can be detachably fastened, wherein the actuation of the at least one electrical furniture drive of the moveable furniture part can be prevented when there is a risk of it colliding with a further moveable furniture part—which has been moved out of its closed position—by the configuration of the control connections.

The invention concerns an arrangement comprising at least two articles of furniture and a securing or safety apparatus for at least one electric furniture drive of a movable furniture part, wherein the safety apparatus prevents simultaneous opening of movable furniture parts which are at risk of colliding.

The invention further concerns articles of furniture comprising at least one safety apparatus as set forth in one of claims 1 through 4.

Such safety apparatuses are already known from the state of the art. Thus for example German utility model DE 20 2009 010 203 U1 shows an arrangement with electric-motor furniture drives and an interface for wireless communication of the furniture drives, wherein the furniture drives can be triggered by way of the wireless communication interface. In that way simultaneous opening of movable furniture parts which are at risk of colliding can be prevented by suitable programming.

The object of the invention is to provide an arrangement comprising at least two articles of furniture and a safety apparatus for electric furniture drives for movable furniture parts, that is improved over the state of the art.

In the arrangement comprising at least two articles of furniture and the safety apparatus according to the invention that is achieved by the features of claim 1.

In other words the configuration of the control connections of the safety apparatus prevents actuation of a furniture drive when there is a risk of collision with a movable furniture part which has been moved out of its closed position while in contrast actuation of the furniture drive is allowed when there is no risk of collision by virtue of the configuration of the control connections of the safety apparatus.

Thus a safety apparatus which is extremely simple to operate is afforded by the pre-configuration of the control connections as it is solely the corresponding occupancy of the control connections with the signal lines of the corresponding electric furniture drives that already defines whether the movable furniture parts can be opened together or whether those movable furniture parts cannot be opened together. Programming of the safety apparatus can thus be eliminated.

That permits fast construction of the articles of furniture and there is no need for further technical devices like computers and so forth to first set the safety apparatus. Thus there is also no need for any special technical previous knowledge and experience on the part of the erector as the signal lines simply have to be only connected to the safety apparatus and no further settings are required.

Preferably it is not just one furniture drive of an article of furniture that is blocked or enabled by the safety apparatus, but all furniture drives of that article of furniture. It will be appreciated that it would equally also be possible for each individual furniture drive of an article of furniture or a combination of various furniture drives to be blocked or enabled by one or more safety apparatuses.

Further advantageous embodiments of the invention are defined in the appendant claims.

It has proven to be particularly advantageous if the safety apparatus has three control connections and at least two—preferably three—electric furniture drives are connected to the control connections of the safety apparatus, wherein actuation of the electric furniture drives connected to two control connections can be prevented when there is a risk of collision of the movable furniture parts with a sensor connected to the third control connection or connected third electric furniture drive of a movable furniture part—which has been moved out of its closed position—by the configuration of the control connections. It is thus possible in a simple fashion to define which electric furniture drives can be actuated simultaneously and which cannot.

In a preferred embodiment it can be provided that the configuration of the control connections is already afforded by the wiring of the safety apparatus. In that way it is possible to manufacture a particularly simple safety apparatus as configuring of the control connections does not have to be effected thereon either by touch switches or the like as that is already fixedly predetermined by the wiring.

It can further preferably be provided that the safety apparatus is in the form of a self-contained component. The fact that it is in the form of a self-contained component means that the safety apparatus can be mounted at any desired location—preferably anywhere on the furniture carcass—which is preferably readily accessible and to which the electric furniture drives can be connected. Being in the form of a self-contained component with its own housing or its own base plate means that the safety apparatus is thus independent of other control devices, mechanical setting units and the electrical furniture drives and therefore does not have to be structurally linked thereto.

Further details and advantages of the present invention will be described more fully hereinafter by means of the specific description with reference to the embodiments by way of example illustrated in the drawings in which:

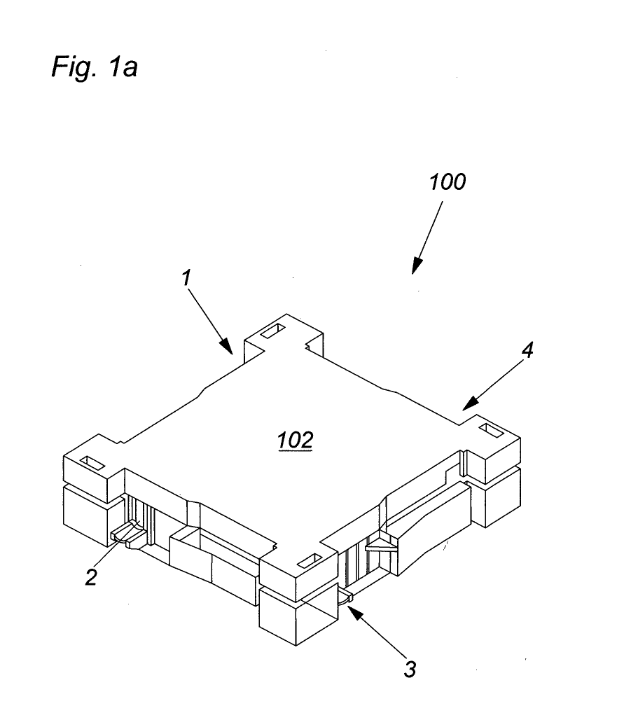

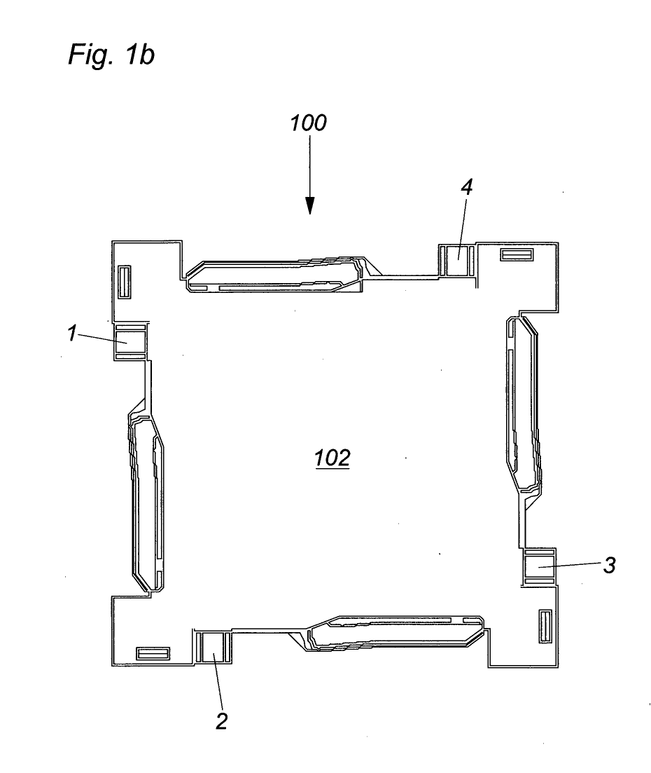

FIG. 1a shows a perspective view of a safety apparatus with three control connections for electric furniture drives for movable furniture parts,

FIG. 1b shows a plan view of the safety apparatus as shown in FIG. 1a,

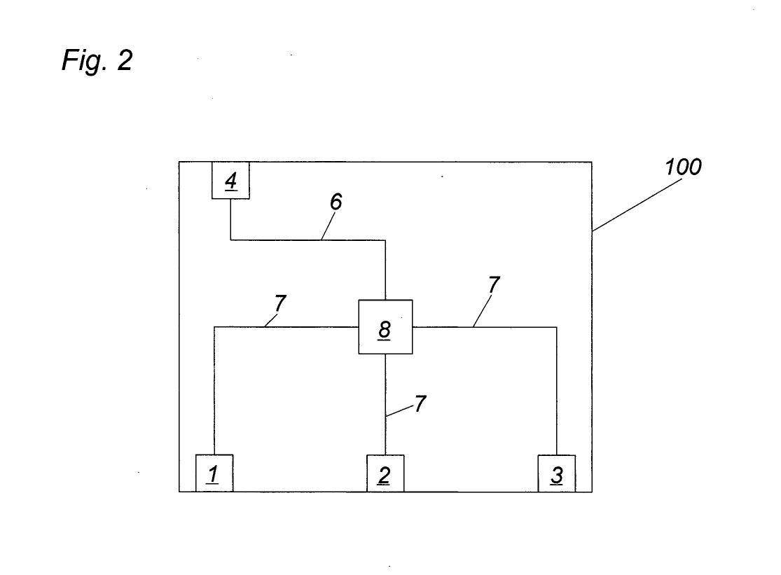

FIG. 2 shows a diagrammatic view of the safety apparatus,

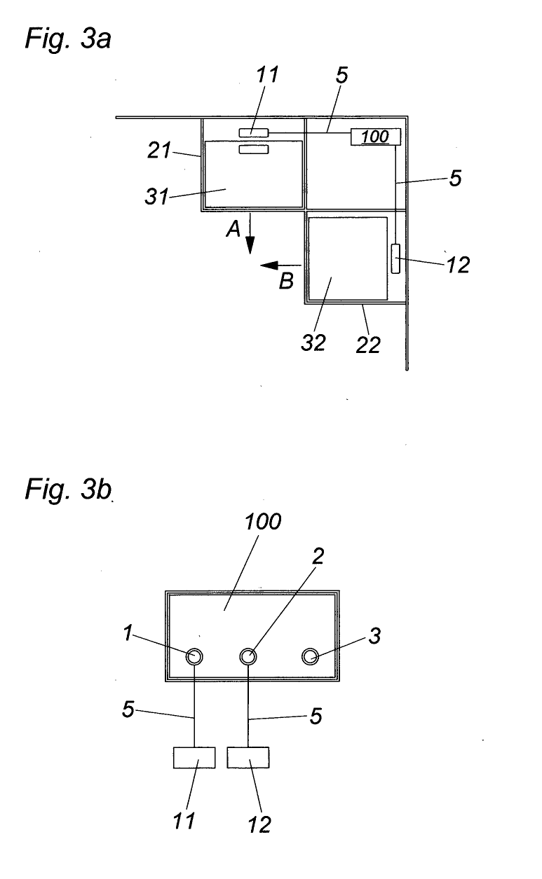

FIG. 3a shows a diagrammatic plan view of two articles of furniture in an arrangement which is at risk of collision,

FIG. 3b shows a diagrammatic view of the occupancy of the control connections of the safety apparatus in relation to FIG. 3a,

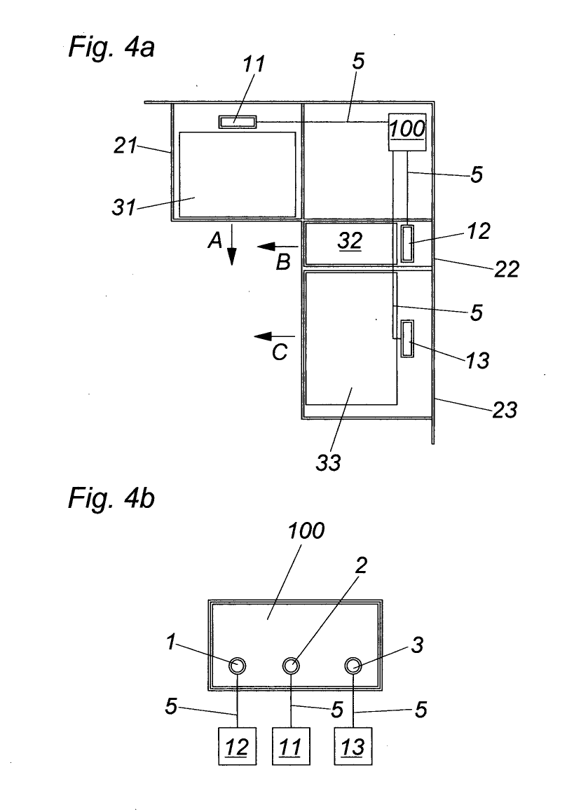

FIG. 4a shows a diagrammatic plan view of three articles of furniture in an arrangement which is in part at risk of collision,

FIG. 4b shows a diagrammatic view of the occupancy of the control connections of the safety apparatus in relation to FIG. 4a,

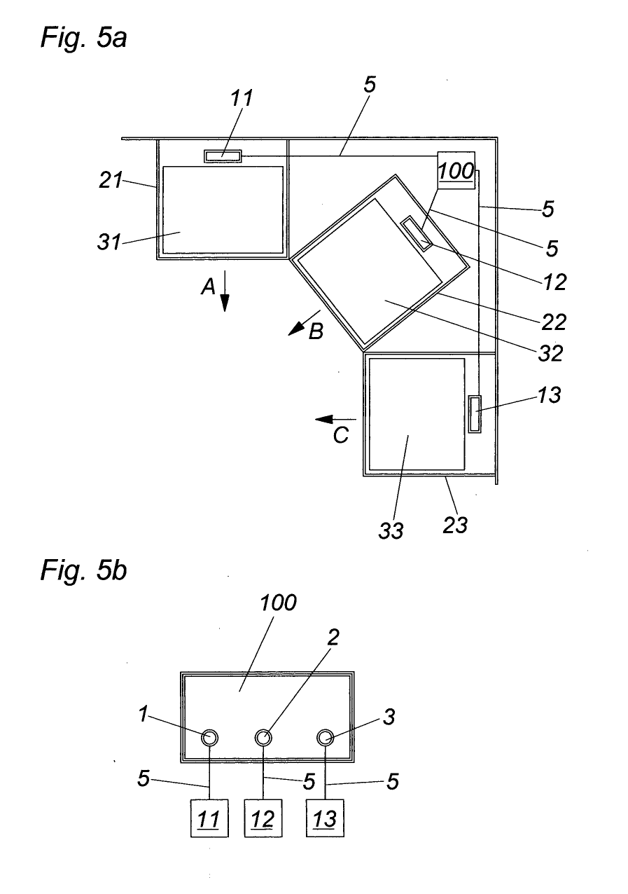

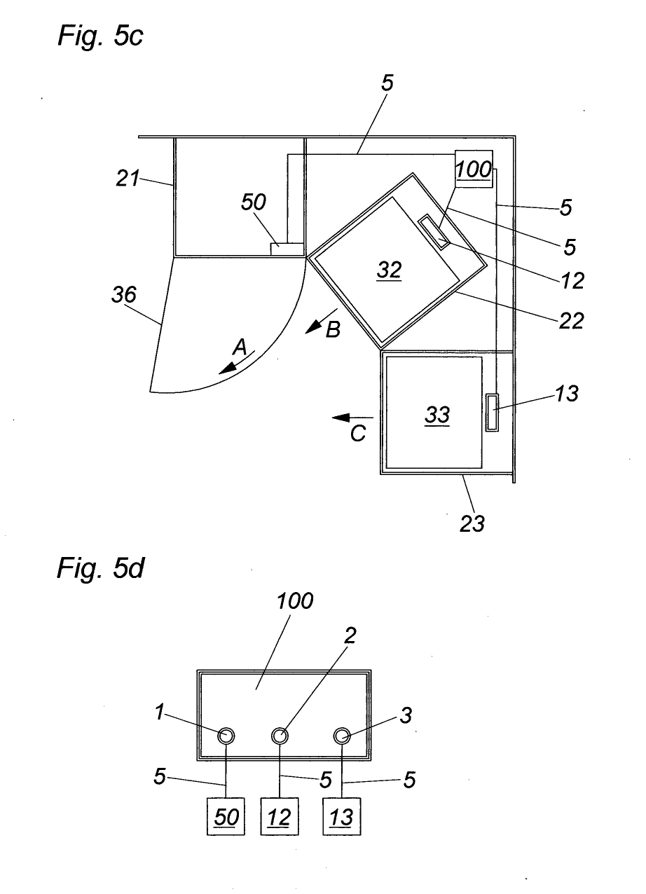

FIG. 5a shows a diagrammatic view of a further variant of three articles of furniture which are in part at risk of collision,

FIG. 5b shows a diagrammatic view of the occupancy of the safety apparatus in FIG. 5a,

FIG. 5c shows a diagrammatic view of a further variant with three articles of furniture which are in part at risk of collision,

FIG. 5d shows a diagrammatic view of the occupancy of the safety apparatus in FIG. 5c,

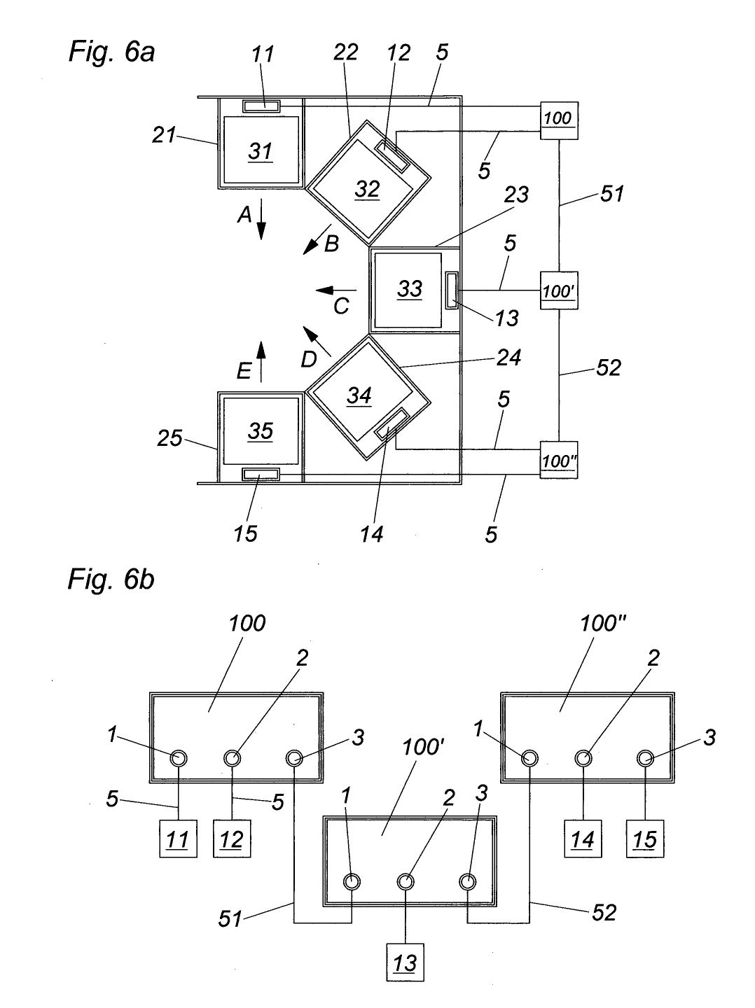

FIG. 6a shows a diagrammatic plan view of the arrangement of five articles of furniture in an arrangement which is in part at risk of collision, and

FIG. 6b shows a diagrammatic view of the occupancy of the control connections of a plurality of safety apparatuses as shown in FIG. 6a.

FIG. 1a shows a perspective view of an embodiment of the safety apparatus 100. The safety apparatus 100 has its own independent housing 102. In addition this embodiment of the safety apparatus 100 has four connections 1, 2, 3 and 4, wherein the connections 1, 2 and 3 are provided for signal lines 5 (not shown) of electric furniture drives 11, 12 and 13 (also not shown) (or sensors 50 of movable furniture parts 36, see in that respect FIG. 5c). The connection 4 serves for the voltage supply.

FIG. 1b shows a plan view of a safety apparatus 100 as shown in FIG. 1a. In this case it is also possible to see the control connections 1, 2 and 3 for the signal lines 5 (not shown) of the electric furniture drives or sensors (not shown). The safety apparatus 100 also has the voltage supply connection 4. It can be clearly seen from FIGS. 1a and 1b that the fact that the safety apparatus 100 is in the form of a self-contained component 102 means that the safety apparatus 100 is not linked to other apparatuses—such as for example control devices or electric furniture drives and so forth—but is independent thereof.

FIG. 2 shows a diagrammatic view in the form of a block circuit diagram of a safety apparatus 100. In this case the safety apparatus 100 has the above-mentioned control connections 1, 2 and 3 for the electric furniture drives and/or sensors (not shown) of movable furniture parts. This Figure also shows the voltage supply connection 4. Both the voltage supply connection 4 and also the three control connections 1, 2 and 3 are connected by way of lines 7 or by way of the voltage supply line 6 respectively to the control 8—which is in this embodiment in the form of a microcontroller. In that case the control 8 is so pre-configured that it either allows or prevents simultaneous or successive actuation of electric furniture drives connected to the control connections 1, 2 and 3.

In this embodiment the control 8 is configured in such a way that actuation of the electric furniture drives connected to the two control connections 1 and 3 can be prevented when there is a risk of collision of the movable furniture parts with a sensor connected to the third control connection 2 or connected third electric furniture drive of a movable furniture part—which has been moved out of its closed position—, by virtue of the configuration of the control connections 1, 2 and 3. As already mentioned in that case the configuration of the control 8 and thus the configuration of the control connections 1, 2 and 3 is already predetermined from the outset (from the factory). In this preferred embodiment that configuration can no longer be subsequently altered.

In this preferred embodiment therefore the control connection 2 is never enabled by the control 8, at the same time as the other two control connections 1 and 3. In contrast the control connections 1 and 3 are enabled at the same time by the control 8.

FIG. 3a shows a diagrammatic plan view of two articles of furniture 21 and 22. The two articles of furniture 21 and 22 each have a respective electric furniture drive 11 and 12. The electric furniture drives 11 and 12 serve for ejection of the movable furniture parts 31 and 32. In this case the movable furniture parts are ejected in the directions indicated by the arrows A and B respectively by the electric furniture drives 11 and 12. The arrangement of the two articles of furniture 11 and 12 in a corner position gives rise to the risk of collision of the movable furniture parts 31 and 32 if they were to be extended jointly by the furniture drives 11 and 12.

To prevent that the electric furniture drives 11 and 12 are connected to the safety apparatus 100 by way of signal lines 5. The safety apparatus 100 is pre-configured in such a way that it prevents simultaneous opening of the movable furniture parts 31 and 32 which are at risk of collision, by actuation of the electric furniture drive 11 of the movable furniture part 31 with the movable furniture part 32—which has been moved out of its closed position—being prevented by the configuration of the control connections 1 and 2 (see FIG. 3b) and equally by actuation of the electric furniture drive 12 of the movable furniture part 32 with the movable furniture part 31—which has been moved out of its closed position—being prevented by the configuration of the control connections 1 and 2 (see FIG. 3b).

FIG. 3b shows a diagrammatic view of the safety apparatus 100, wherein it has three control connections 1, 2 and 3 for the connection of electric furniture drives 11 and 12 connected by way of signal lines 5.

The safety apparatus 100 or its control connections 1, 2 and 3 are in this case pre-configured in such a way that the connection of the electric furniture drives 11 and 12 to adjacent connections 1 and 2 or 2 and 3 prevents simultaneous opening of the movable furniture parts 31 and 32 of the articles of furniture 21 and 22 (not shown), by the safety apparatus 100.

As, as shown in FIG. 3a, the two articles of furniture 21 and 22 are in a placement which is at risk of collision the connection of the electric furniture drives 11 and 12 to adjacent connections 1 and 2 mean that simultaneous or successive opening of the movable furniture parts 31 and 32 of the two articles of furniture 21 and 22 is prevented by the safety apparatus 100.

The pre-configuration of the safety apparatus 100, by virtue of the occupancy of the control connections, permits simultaneous actuation of the electric furniture drives 11 and 12 when they are connected to the control connections 1 and 3 whereas simultaneous opening is prevented when they are connected to the connections 1 and 2 or to the connections 2 and 3.

It will be appreciated that this pre-configuration could also turn out to be different but in practice it has been found that this pre-configuration is practicable for the erector.

It will be appreciated that the control connections 1, 2 and 3 could also be pre-configured differently or also marked differently (for example in color) in order to identify which control connections are to be occupied to prevent or permit simultaneous or successive openings.

FIG. 4a shows the arrangement of three articles of furniture 21, 22 and 23 in a corner placement, wherein the movable furniture parts 31 of the article of furniture 21 are in a position which is at risk of collision both with the movable furniture parts 32 of the article of furniture 22 and also with the movable furniture parts 33 of the article of furniture 23. In contrast the movable furniture parts 32 and 33 of the articles of furniture 22 and 23 are not in a position which is at risk of collision with each other as the movement of the movable furniture parts 32 and 33 in the directions B and C respectively is in parallel relationship, whereas the direction of movement A of the movable furniture parts 31 of the article of furniture 21 crosses with the directions of movement B and C of the movable furniture parts 32 and 33 of the articles of furniture 22 and 23.

The electric furniture drives 11, 12 and 13 of the articles of furniture 21, 22 and 23 are in turn connected to the safety apparatus 100 by way of signal lines 5.

It will be appreciated that it would equally be also possible for the electric furniture drives 11, 12 and 13 of the articles of furniture 21, 22 and 23 not to be connected directly to the safety apparatus 100 by way of the control lines 5, but instead or in addition to the control lines 5 it is possible for a circuit for wireless signal transmission to be connected between the furniture drives and the safety apparatus 100 and for it to be connected for example to one or to all control connections 1, 2, 3.

FIG. 4b shows the occupancy of the control connections 1, 2 and 3 of the safety apparatus 100 by way of the signal lines 5 with the electric furniture drives 11, 12 and 13 of the articles of furniture 21, 22 and 23 (not shown).

As already mentioned in relation to the FIG. 3b the safety apparatus 100 or its control connections 1, 2 and 3 are pre-configured in such a way that the control connections 1 and 2 and the control connections 2 and 3 prevent extension of connected furniture drives 11, 12 or 12 and 13 respectively at the same time or in succession with each other whereas the control connections 1 and 3 allow simultaneous actuation of the electric furniture drives 11 and 13 connected thereto.

The connection of the electric furniture drive 11 of the article of furniture 21 by way of the signal line 5 to the control connection 2 of the safety apparatus 100 provides that simultaneous actuation of the electric furniture drive 11 both with the electric furniture drive 12 connected to the control connection 1 and also with the electric furniture drive 13 connected to the control connection 3 is prevented as those two are adjacent to the control connection 2. In contrast the electric furniture drives 12 and 13 of the articles of furniture 22 and 23 can be simultaneously actuated as they are connected to the control connections 1 and 3 and therefore the safety apparatus 100 does not prevent them from being actuated simultaneously.

FIG. 5a shows a further corner variant of three articles of furniture 21, 22 and 23 in a placement which is in part at risk of collision. In that case the movable furniture parts 31 of the article of furniture 21 can collide with the movable furniture parts 32 of the article of furniture 22, and likewise the movable furniture parts 32 of the article of furniture 22 could collide with the movable furniture parts 33 of the article of furniture 23. In contrast the movable furniture parts 31 of the article of furniture 21 cannot collide with the movable furniture parts 33 of the article of furniture 23. The electric furniture drives 11, 12 and 13 are again connected to the safety apparatus 100 by way of the control lines 5.

The occupancy of the safety apparatus 100 is shown in FIG. 5b. As the movable furniture parts 32 of the article of furniture 22 could collide with the movable furniture parts 31 and 33 the signal line 5 of the electric furniture drive 12 is connected to the control connection 2 of the safety apparatus 100 as it is so pre-configured that actuation of the electric furniture drive 12 connected thereto simultaneously with the electric furniture drives 11 and 13 connected to the other two connections 1 and 3 is prevented. In contrast the movable furniture parts 31 and 33 of the articles of furniture 21 and 23 can be extended simultaneously as the electric furniture drives 11 and 13 are connected to the control connections 1 and 3 and they allow simultaneous actuation.

FIG. 5c shows a further corner variant of three articles of furniture 21, 22 and 23 in a placement which is in part at risk of collision, similarly to the situation shown in FIG. 5a, with the difference that in this case the article of furniture 21 does not have a furniture drive but a movable furniture part 36—in the form of a door—and a sensor 50 which detects an open position of the door 36.

Once again the door 36 of the article of furniture 21 could collide with the movable furniture parts 32 of the article of furniture 22 and equally the movable furniture parts 32 of the article of furniture 22 could collide with the movable furniture parts 33 of the article of furniture 23. In contrast the door 36 of the article of furniture 21 cannot collide with the movable furniture parts 33 of the article of furniture 23. The electric furniture drives 12 and 13 and the sensor 50 are again connected to the safety apparatus 100 by way of the control lines 5.

The occupancy of the inputs 1, 2 and 3 of the safety apparatus 100 is shown in FIG. 5d. As the movable furniture parts 32 of the article of furniture 22 could collide with the door 36 and the movable furniture parts 33 the signal line 5 of the electric furniture drive 12 is connected to the control connection 2 of the safety apparatus 100 as it is pre-configured in such a way that actuation of the electric furniture drive 12 connected thereto simultaneously with the electric furniture drive 13 connected to the other two connections 1 and 3 and the activated sensor 50 (if the latter detects an opened door 36) is prevented. The door 36 and the movable furniture part 33 of the articles of furniture 21 and 23 in contrast can be moved simultaneously as the sensor 50 and the electric furniture drive 13 are connected to the control connections 1 and 3 and they allow simultaneous actuation.

It will be appreciated that it could also be envisaged that two doors 36 would be provided, with corresponding sensors 50, on the articles of furniture 21 and 23, and there would be only one electric furniture drive 12 on the article of furniture 22. The safety apparatus 100 would then equally—with a suitable connection configuration—prevent collisions of the movable furniture part 32 with the two doors 36.

FIG. 6a shows the arrangement of five articles of furniture 21, 22, 23, 24 and 25 which are in part arranged in a placement which is at risk of collision.

The movable furniture part
32 could collide with the movable furniture parts 31 and 33 of the articles of furniture 21 and 23 (see FIGS. 5a),
33 could collide with the movable furniture parts 32 and 34, and
34 could collide with the movable furniture parts 35 and 33.

In contrast there cannot be any collision of the movable furniture part
31 with the movable furniture parts 33, 34 and 35,
32 with the movable furniture parts 34 and 35,
33 with the movable furniture parts 31 and 35,
34 with the movable furniture parts 31 and 32, and
35 with the movable furniture parts 31 and 33.

That can be seen from the illustrated directional arrows A, B, C, D and E of the possible directions of extension movement of the movable furniture parts 31, 32, 33, 34 and 35 of the corresponding articles of furniture 21, 22, 23, 24 and 25.

To control which furniture drives 11, 12, 13, 14 and 15 may be actuated simultaneously or not simultaneously, the electric furniture drives 11, 12, 13, 14 and 15 are respectively connected by way of signal lines 5 to the three safety apparatuses 100, 100′ and 100″—which are all of the same construction—.

FIG. 6b now shows the occupancy of the safety apparatuses 100, 100′ and 100″ to implement the furniture arrangement as shown in FIG. 6a and to provide for extension of the movable furniture parts 31, 32, 33, 34 and 35 of the articles of furniture 21, 22, 23, 24 and 25 illustrated there. The safety apparatuses 100, 100′ and 100″ are pre-configured in the same manner as already mentioned in the preceding embodiments, namely in such a way that electric furniture drives connected to adjacent connections cannot be actuated together.

In that respect the electric furniture drive 11 is connected by way of a signal line 5 to the control connection 1 of the safety apparatus 100 and the electric furniture drive 12 is connected by way of a signal line 5 to the control connection 2 of the safety apparatus 100. Thus by virtue of the configuration of the safety apparatus 100 those two furniture drives 11 and 12 cannot be simultaneously actuated. A connecting line 51 leads from the control connection 3 of the safety apparatus 100 to the control connection 1 of the second safety apparatus 100′. The electric furniture drive 13 is connected by way of the signal line 5 to the control connection 2 of the second safety apparatus 100′. A connecting line 52 leads from the control connection 3 of the second safety apparatus 100′ to the control connection 1 of the third safety apparatus 100″. The electric furniture drive 14 is connected to that third safety apparatus 100″ by way of the signal line 5 at the control connection 2 while the electric furniture drive 15 is connected by way of the signal line 5 to the control connection 3 of the third safety apparatus 100″.

That connection occupancy of the electric furniture drives 11 through 15 by way of the signal lines 5 and by way of the connection of the safety apparatus 100 to the safety apparatus 100′ by way of the control connections 3 and 1 and by the connection of the safety apparatus 100′ to the safety apparatus 100″ by way of the control connections 3 and 1 means that the configuration of those three safety apparatuses 100, 100′ and 100″ prevents simultaneous actuation of movable furniture parts which are at risk of collision whereas it allows simultaneous actuation of furniture parts which are not at risk of collision.

It could naturally also be envisaged that a safety apparatus be provided, which has more than three control connections in order to cover the furniture situation as shown in FIG. 6a. For cost reasons however it is better to provide a single safety apparatus 100 with which all possible conceivable installation situations can be managed—by the combination of a plurality of identical safety apparatuses 100.

Even if the invention has been described in specific terms by reference to the illustrated embodiment it will be appreciated that the subject of the application is not limited to that embodiment. Rather it will be appreciated that measures and modifications which serve to carry the concept of the invention into effect are certainly conceivable and desirable.

1. An arrangement comprising at least two articles of furniture and a safety apparatus for at least one electric furniture drive of a movable furniture part, wherein the safety apparatus prevents simultaneous opening of movable furniture parts which are at risk of colliding, wherein the safety apparatus has at least two control connections to which signal lines of sensors of movable furniture parts and/or signal lines of the at least one electric furniture drive can be releasably fixed, wherein the actuation of the at least one electric furniture drive of the movable furniture part can be prevented when there is a risk of collision with a further movable furniture part—which has been moved out of its closed position—by the configuration of the control connections, wherein said safety apparatus prevents simultaneous opening of the movable furniture parts in the at least two articles of furniture which are at risk of colliding.

2. The arrangement according to claim 1, wherein the safety apparatus has three control connections to which signal lines of sensors of movable furniture parts and/or signal lines of the at least one electric furniture drive can be releasably fixed, wherein the actuation of the at least one electric furniture drive of the movable furniture part can be prevented when there is a risk of collision with a further movable furniture part—which has been moved out of its closed position—by the configuration of the control connections, wherein said safety apparatus prevents simultaneous opening of the movable furniture parts in the at least two articles of furniture which are at risk of colliding.

3. The arrangement according to claim 1 wherein the safety apparatus has three control connections and at least two electric furniture drives are connected to the control connections of the safety apparatus, wherein actuation of the electric furniture drives connected to two control connections can be prevented when there is a risk of collision of the movable furniture parts with a sensor connected to the third control connection or connected third electric furniture drive of a movable furniture part—which has been moved out of its closed position—by the configuration of the control connections.

4. The arrangement according to claim 3 wherein the safety apparatus has three control connections and three electric furniture drives are connected to the control connections of the safety apparatus, wherein actuation of the electric furniture drives connected to two control connections can be prevented when there is a risk of collision of the movable furniture parts with a sensor connected to the third control connection or connected third electric furniture drive of a movable furniture part—which has been moved out of its closed position—by the configuration of the control connections.

5. The arrangement according to claim 1 wherein the configuration of the control connections is already afforded by the wiring of the safety apparatus.

6. The arrangement according to claim 1 wherein the safety apparatus is in the form of a self-contained component.
